(19) United States
(12) Patent Application Publication
(10) Pub. No.: US 2024/0019451 A1
(43) Pub. Date: Jan. 18, 2024

(54) TEMPERATURE ADJUSTMENT SYSTEM FOR AUTOMATIC ANALYZER DEVICE

(71) Applicant: SEKISUI MEDICAL CO., LTD., Tokyo (JP)

(72) Inventor: Yoshihiro YANO, Tokyo (JP)

(21) Appl. No.: 18/476,326

(22) Filed: Sep. 28, 2023

Related U.S. Application Data
(63) Continuation of application No. PCT/JP2022/015916, filed on Mar. 30, 2022.

(30) Foreign Application Priority Data
Mar. 31, 2021 (JP) 2021-059833

(51) Int. Cl. G01N 35/00

(52) U.S. Cl. CPC G01N 35/00584; G01N 2035/00346

(57) ABSTRACT

A temperature adjustment system includes: a temperature adjustment unit for adjusting a temperature of a liquid required for measurement to a desired temperature; a measurement unit for obtaining measurement information of a measurement object-containing liquid; a connection flow path connecting the temperature adjustment unit and the measurement unit; temperature detection units and to detect temperatures of the liquids in the temperature adjustment unit and the measurement unit; and a control unit to perform liquid temperature control to control a temperature of the temperature adjustment unit such that the temperature of the liquid in the measurement unit becomes a target temperature while considering a temperature change associated with a flow of the liquids from the temperature adjustment unit to the measurement unit through the connection flow path, based on the temperature of the liquid in the measurement unit and the temperature of the liquid in the temperature adjustment unit.

### RELATED APPLICATIONS

The present application is a continuation of International Application No. PCT/JP2022/015916, filed Mar. 30, 2022, which claims priority from Japanese Patent Application No. 2021-059833, filed Mar. 31, 2021, the disclosures of which applications are hereby incorporated by reference here in their entirety.

### TECHNICAL FIELD

The present invention relates to a temperature adjustment system for an automatic analysis device capable of obtaining measurement information on various test items by reacting a sample (specimen) such as blood or urine and various reagents with each other and by measuring reaction processes.

### BACKGROUND ART

In the related art, there are known various forms of automatic analysis devices capable of obtaining measurement information on various test items by reacting a biological sample such as blood or urine with various reagents and by measuring reaction processes and reaction results, such as a blood coagulation analysis device and an analysis device using immunoassay. For example, a specimen that is a sample to be measured may be dispensed from a specimen vessel into a reaction vessel, a reagent corresponding to a test item may be dispensed and mixed with the dispensed specimen, and various measurements and analyses may be performed (for example, Patent Document 1 and the like). For example, in an automatic analysis device for clinical testing, a certain amount of sample and reagent are dispensed and reacted with each other, and then the amount of luminescence or absorbance of a reaction liquid after a certain time are measured, and a test value such as the concentration, activity value, or the like of a measurement substance is obtained based on the measurement result (photometry result).

In such an automatic analysis device, it is known that when the sample (specimen), reagent (including a calibration solution), or the like moves to a measurement unit via a flow path, due to a change in the temperature thereof caused by the outside air temperature, a variation occurs in the temperature of a measurement object in the measurement unit, and affects a measurement value. For this reason, in order to suppress the adverse influence and obtain a precise measurement value, a method for controlling the temperature of the measurement object or the flow path has been studied in the related art.

As one example of such a temperature control method, Patent Document 2 discloses an electrolyte analysis device in which a liquid-phase measurement object such as a sample or a reagent (including a calibration solution) is heated by a temperature adjustment block and then is sent to and measured in an electrode block that is a measurement unit including various electrodes and a heater. In the electrolyte analysis device, the output of heaters installed in the electrode block and the temperature adjustment block is controlled according to the outside air temperature, to adjust the temperature of each of the blocks to an appropriate temperature.

### CITATION LIST

### Patent Document

Patent Document 1: JP 2019-135497 A
Patent Document 2: JP 2007-93252 A

### SUMMARY OF THE INVENTION

### Problem to be Solved by the Invention

However, when the temperature of the electrode block and the temperature adjustment block is controlled according to the outside air temperature as in Patent Document 2, if there is a machine-to-machine difference in the heat insulation of a flow path from the temperature adjustment block to the electrode block that is a measurement unit, the outside air temperature affects the machine-to-machine difference. Therefore, unless the output control value for temperature adjustment is adjusted for each machine, it is difficult to accurately control the temperature of the measurement unit. Particularly, when the temperature adjustment block and the electrode block are separated from each other, and the distance therebetween is such that the measurement object heated or cooled by the temperature adjustment block undergoes a decrease (cooling) or increase in temperature until reaching the electrode block that is a measurement unit, it becomes more difficult to set the temperature of the measurement object to a desired temperature in an electrode flow path based on the outside air temperature.

The invention has been made in view of the foregoing problems, and an object of the invention is to provide a temperature adjustment system for an automatic analysis device, which can accurately control the temperature of a measurement object-containing liquid to a target temperature in a measurement unit when a temperature adjustment unit and the measurement unit in the analysis device are separated from each other.

### Means for Solving Problem

In order to achieve the foregoing object, according to the invention, there is provided a temperature adjustment system for an automatic analysis device to obtain measurement information on a predetermined analysis item by processing and measuring a specimen, the system including: a temperature adjustment unit for adjusting a temperature of a liquid required for measurement to a desired temperature; a measurement unit for obtaining measurement information on a predetermined analysis item of a measurement object-containing liquid obtained by adding a measurement object to the liquid required for measurement, the liquid temperature of the liquid required for measurement being adjusted by the temperature adjustment unit; a connection flow path connecting the temperature adjustment unit and the measurement unit; a temperature detection unit to detect a temperature of the liquid required for measurement in the temperature adjustment unit and a temperature of the measurement object-containing liquid in the measurement unit; and a control unit to receive the detected temperatures from the temperature detection unit, to calculate a temperature change associated with a flow of the liquid required for measurement and the measurement object-containing liquid from the temperature adjustment unit to the measurement unit through the connection flow path, based on the temperature of the measurement object-containing liquid in the measurement unit and the temperature of the liquid required for measurement in the temperature adjustment unit, and to perform liquid temperature control to control a temperature of the temperature adjustment unit such that the temperature of the measurement object-containing liquid in the measurement unit becomes a target temperature, based on the target temperature and the temperature change.

According to the automatic analysis device with this configuration, the liquid temperature control is performed not only to control the temperature of the temperature adjustment unit according to the outside air temperature, but also to measure the temperature of the measurement object-containing liquid in the measurement unit and the temperature of the liquid required for measurement in the temperature adjustment unit and control the temperature of the temperature adjustment unit such that the temperature of the measurement object-containing liquid in the measurement unit becomes the target temperature, based on the temperatures. For this reason, even when there is a machine-to-machine difference in the heat insulation of the device, the temperature of the measurement object-containing liquid can be accurately controlled to the target temperature in the measurement unit without performing an adjustment for each machine.

Moreover, in such liquid temperature control, according to this configuration, the temperature of the temperature adjustment unit is controlled in consideration of the temperature change associated with the flow of the liquid required for measurement and the measurement object-containing liquid from the temperature adjustment unit to the measurement unit through the connection flow path. For this reason, even when the temperature adjustment unit and the measurement unit are spatially separated from each other by a distance such that the temperatures of the liquid required for measurement and the measurement object-containing liquid adjusted by the temperature adjustment unit change until the liquids reach the measurement unit, the temperature of the measurement object-containing liquid can be accurately set to the desired temperature in the measurement unit.

Incidentally, in this configuration, the “liquid required for measurement” refers to a reagent and other various liquids used for measurement, excluding a specimen. In addition, the “measurement object-containing liquid” refers to, for example, a liquid that is supplied to the measurement unit in a state required for measuring a specimen for a predetermined analysis item, such as a mixture (reactant) of a sample (specimen) and a reagent (calibration solution). Further, the “measurement object” is a substance to be measured by the measurement unit, and refers to the specimen itself or a substance contained in the specimen. In addition, in this configuration, the “temperature detection unit” individually detects the temperature of the liquid required for measurement in the temperature adjustment unit or the temperature of the measurement object-containing liquid in the measurement unit simultaneously or with shifting time, and may be individually provided in association with each of the temperature adjustment unit and the measurement unit. In addition, in this configuration, particularly, it is assumed that the liquid required for measurement (not containing the specimen) and the measurement object-containing liquid (containing the specimen) are mixed (or the liquid required for measurement and the measurement object added to the liquid are mixed) and flow to the measurement unit; however, naturally, the invention is not limited to such a mode. In addition, the object of which the temperature is adjusted by the temperature adjustment unit is primarily the liquid required for measurement (not containing the specimen), but is not limited thereto. In addition, the adjustment of temperature (temperature adjustment) in the temperature adjustment unit includes not only heating but also cooling or heat retention (constant temperature).

In addition, in the liquid temperature control with this configuration, it is preferable that the control unit controls the temperature of the temperature adjustment unit while considering a temperature difference between the temperature of the measurement object-containing liquid in the measurement unit and a temperature at a past time the liquid required for measurement passes through the temperature adjustment unit, the liquid required for measurement being contained in the measurement object-containing liquid measured for the temperature, or a temperature in a period including the past time, as the temperature change associated with the flow of the liquid required for measurement and the measurement object-containing liquid. According to this configuration, practically, regarding the temperatures of the liquid required for measurement in the temperature adjustment unit and the measurement object-containing liquid in the measurement unit at the same time, the value of the temperature of the liquid required for measurement in the temperature adjustment unit can be the past value of the temperature (pre-stage adjustment temperature) of the measurement object-containing liquid in the measurement unit. Namely, the value of the temperature of the liquid required for measurement in the temperature adjustment unit can be brought close to the past value for bringing the temperature of the measurement object-containing liquid in the measurement unit to an appropriate target temperature.

For this reason, the temperature change associated with the flow (movement) of the liquid required for measurement and the measurement object-containing liquid from the temperature adjustment unit to the measurement unit through the connection flow path can be accurately detected, and the set temperature of the temperature adjustment unit can be accurately determined such that the temperature of the measurement object-containing liquid in the measurement unit becomes the target temperature. Here, the “set temperature of the temperature adjustment unit” is set to be the target temperature of the measurement object-containing liquid in the measurement unit+the temperature change associated with the flow of the liquid required for measurement and the measurement object-containing liquid from the temperature adjustment unit to the measurement unit through the connection flow path. Namely, the set temperature of the temperature adjustment unit is set to correct a deviation between the temperature of the measurement object-containing liquid flowing through the measurement unit and the changing temperature when the liquid required for measurement which flows through the temperature adjustment unit moves to the measurement unit thereafter.

In addition, in this configuration, it is preferable that in the liquid temperature control, when the temperature of the measurement object-containing liquid in the measurement unit changes at a predetermined cycle, the control unit controls the temperature of the temperature adjustment unit while considering a difference between an average value of the temperature of the measurement object-containing liquid in the measurement unit over a period of one cycle, the temperature changing over the predetermined cycle, and an average value of the temperature of the liquid required for measurement in the temperature adjustment unit, the temperature changing over a past predetermined period including or not including the period of one cycle, as the temperature change associated with the flow of the liquid required for measurement and the measurement object-containing liquid over the predetermined one cycle. Incidentally, when the past predetermined period for calculating the average value of the temperature of the liquid in the temperature adjustment unit includes the period of the predetermined one cycle in which the average value of the temperature of the liquid in the measurement unit is calculated, the past predetermined period may be a period that is continuous with the predetermined one cycle.

In such a manner, a calculation period for obtaining the average value (moving average) of the changing temperature of the liquid required for measurement in the temperature adjustment unit includes a period in the past of a calculation period for obtaining the average value (moving average) of the changing temperature of the measurement object-containing liquid in the measurement unit. Accordingly, the temperatures of the liquid required for measurement in the temperature adjustment unit at the measurement time and the liquid required for measurement in the measurement object-containing liquid in the measurement unit can include a past temperature when the liquids pass through the temperature adjustment unit, or can approach the past temperature.

Namely, the value of the temperature of the liquid required for measurement in the temperature adjustment unit can be brought close to the past value of the temperature of the measurement object-containing liquid in the measurement unit. For this reason, the temperature change associated with the flow of the liquid required for measurement and the measurement object-containing liquid from the temperature adjustment unit to the measurement unit through the connection flow path can be accurately detected, and the set temperature of the temperature adjustment unit can be accurately determined such that the temperature of the measurement object-containing liquid in the measurement unit becomes the target temperature.

In other words, at the same time for the liquid required for measurement in the temperature adjustment unit and the measurement object-containing liquid in the measurement unit, the deviation between the temperature of the measurement object-containing liquid flowing through the measurement unit and the temperature that the liquid required for measurement which flows through the temperature adjustment unit can reach in the measurement unit thereafter can be corrected. Here, the “set temperature of the temperature adjustment unit” is the target temperature of the measurement object-containing liquid in the measurement unit+the temperature change associated with the flow of the liquid required for measurement and the measurement object-containing liquid from the temperature adjustment unit to the measurement unit through the connection flow path.

Further, a correction can be made while also considering a temperature change caused by the mixture of the liquid required for measurement and the measurement object-containing liquid. Incidentally, it is preferable that a period “spanning the past predetermined period including or not including the one cycle” as the period for calculating the average value (moving average) of the changing temperature of the liquid required for measurement in the temperature adjustment unit is, for example, a period going back two to four cycles (for example, that is continuous with the one cycle) including the predetermined one cycle. However, a period over past one or more cycles not including the predetermined one cycle may be adopted as the period for calculating the average value (moving average) of the changing temperature of the liquid required for measurement in the temperature adjustment unit.

In addition, in this configuration, it is preferable that the control unit updates the temperature change associated with the flow of the liquid required for measurement and the measurement object-containing liquid, every predetermined time, and determines a set temperature of the temperature adjustment unit such that the temperature of the measurement object-containing liquid in the measurement unit becomes a target temperature, based on an update result. According to this configuration, since the set temperature of the temperature adjustment unit is sequentially updated such that the temperature of the measurement object-containing liquid in the measurement unit becomes the target temperature, the temperature of the measurement object-containing liquid can be accurately controlled to the target temperature in the measurement unit.

In addition, in this configuration, it is preferable that after a pump to supply the liquid required for measurement to the measurement unit via the temperature adjustment unit is stopped, the control unit performs machine temperature control to control the temperature of the temperature adjustment unit to a predetermined temperature, based on a temperature (in-machine temperature) inside the automatic analysis device. Even when the pump is stopped not to supply the measurement object-containing liquid to the measurement unit, and the temperature of the measurement object-containing liquid in the measurement unit cannot be detected (liquid temperature control cannot be continued), if the machine temperature control is performed instead of the liquid temperature control, compared to when the temperature adjustment control is completely stopped, after the driving of the pump is restarted, the temperature of the measurement object-containing liquid in the measurement unit can reach the target temperature as quickly as possible, which is advantageous. In addition, the measurement (analysis) efficiency of the entire device can be improved and the operating cost of the device can also be reduced by combining the liquid temperature control and the machine temperature control during operation of the device.

In addition, in this configuration, it is preferable that during the liquid temperature control, the control unit updates a set temperature of the temperature adjustment unit every predetermined time such that the temperature of the measurement object-containing liquid in the measurement unit becomes a target temperature, and after the pump is stopped, determines the set temperature immediately before the stop as an initial value of a set temperature of the temperature adjustment unit during the machine temperature control. According to this configuration, when the liquid temperature control is started again after the machine temperature control, the temperature of the measurement object-containing liquid in the measurement unit can reach the target temperature as quickly as possible. Incidentally, it is preferable that in the machine temperature control, the set temperature of the temperature adjustment unit is corrected based on the amount of a change in the in-device temperature from when the initial value of the set temperature of the temperature adjustment unit is acquired.

In addition, in this configuration, it is preferable that after the pump is driven and before the measurement object-containing liquid is measured by the measurement unit during the liquid temperature control, instead of the measurement object-containing liquid, a dummy liquid for reducing a time taken for the measurement object-containing liquid in the measurement unit to stabilize at the target temperature is introduced into the measurement unit through the temperature adjustment unit by the pump.

For example, immediately after the pump is driven, since the measurement object-containing liquid cooled by air is sent to the measurement unit, a low temperature of the measurement object-containing liquid is detected as the temperature of the measurement object-containing liquid in the measurement unit in the liquid temperature control. Therefore, the set temperature of the temperature adjustment unit increases. For this reason, the temperature of the measurement object-containing liquid in the measurement unit suddenly increases, so that it takes a long time for the measurement object-containing liquid in the measurement unit to stabilize at the target temperature. However, as in this configuration, before the measurement object-containing liquid is measured by the measurement unit during the liquid temperature control, when instead of the measurement object-containing liquid, the dummy liquid is introduced into the measurement unit through the temperature adjustment unit by driving the pump, and then the liquid temperature control is started, the time taken for the measurement object-containing liquid in the measurement unit to stabilize at the target temperature can be shortened, so that the measurement (analysis) efficiency can be improved.

Incidentally, in this configuration, the “dummy liquid” is a liquid having the effect of shortening the time taken for the measurement object-containing liquid in the measurement unit to stabilize at the target temperature (recovering the measurement object-containing liquid in the measurement unit to the target temperature), and for example, the liquid required for measurement may be used as the dummy liquid.

In addition, in this configuration, it is preferable that an introduction period of the dummy liquid is associated with the temperature inside the automatic analysis device and a time from when the pump is stopped to when a driving of the pump is restarted (stop continuation time of the pump). With such an association, the usage amount of the dummy liquid required to shorten the time taken for the measurement object-containing liquid in the measurement unit to stabilize at the target temperature can be appropriately set, and a situation where the dummy liquid is used wastefully can be avoided.

### Effect of the Invention

According to the invention, in the analysis device in which the temperature adjustment unit and the measurement unit are separated from each other, the temperature of the measurement object-containing liquid in the measurement unit can be accurately controlled to the target temperature. In addition, it is possible to provide the temperature adjustment system for the automatic analysis device, which can accurately control the temperature of the measurement object-containing liquid to the target temperature in the measurement unit without performing an adjustment for each machine even when there is a machine-to-machine difference in the heat insulation of the device.

### BRIEF DESCRIPTION OF DRAWINGS

FIG. 1 is a schematic diagram of a temperature adjustment system for an automatic analysis device according to one embodiment of the invention;

FIG. 2A and FIG. 2B are graphs illustrating the accuracy of liquid temperature control when the in-device temperature is changed, FIG. 2A illustrates a graph when the in-device temperature is gradually decreased, and FIG. 2B illustrates a graph when the in-device temperature is gradually increased;

FIG. 3A, FIG. 3B, FIG. 3C, FIG. 3D, FIG. 3E and FIG. 3F are graphs when the moving average value width of the temperature detection value of a liquid required for measurement in a temperature adjustment unit (period for calculating a moving average value of the changing temperature of the liquid required for measurement in the temperature adjustment unit) is variously changed in consideration of a delay time, FIG. 3A illustrates when the moving average value width is one cycle (period of a predetermined one cycle of a temperature change of a measurement object-containing liquid in a measurement unit) (when the moving average value width is equal to a cycle of the temperature change of the measurement object-containing liquid in the measurement unit), FIG. 3B illustrates when the moving average value width is two cycles (period going back two cycles from the predetermined one cycle of the temperature change of the measurement object-containing liquid in the measurement unit, including the cycle: the same applies hereinafter), FIG. 3C illustrates when the moving average value width is three cycles, FIG. 3D illustrates when the moving average value width is four cycles, FIG. 3E illustrates when the moving average value width is five cycles, and FIG. 3F illustrates when the moving average value width is six cycles;

FIG. 4 is a graph illustrating each measurement result of the in-device temperature, the temperature of the measurement object-containing liquid in the measurement unit, and the set temperature of the temperature adjustment unit when a dummy liquid is not used, and is a graph when liquid temperature control is performed simultaneously with driving a pump and machine temperature control is performed simultaneously with stopping the pump;

FIG. 5 is a diagram illustrating one example of a temperature adjustment cycle of the temperature adjustment system using the dummy liquid;

FIG. 6 is a table of experimental data illustrating the number of required times (the number of cycles) of the dummy liquid required to recover the measurement object-containing liquid in the measurement unit to a target temperature, with respect to the number of idle cycles which is the time (stop continuation time of the pump) from when the pump is stopped to when the driving of the pump is restarted, for each in-device temperature, when a change cycle when the temperature of the measurement object-containing liquid in the measurement unit changes at a predetermined cycle is defined as one cycle; and

FIG. 7 is a table in which the experimental results of FIG. 6 are rewritten as data illustrating the maximum allowable number of idle cycles with respect to the number of required times of the dummy liquid for each in-device temperature.

### MODE(S) FOR CARRYING OUT THE INVENTION

Hereinafter, an embodiment of the invention will be described with reference to the drawings.

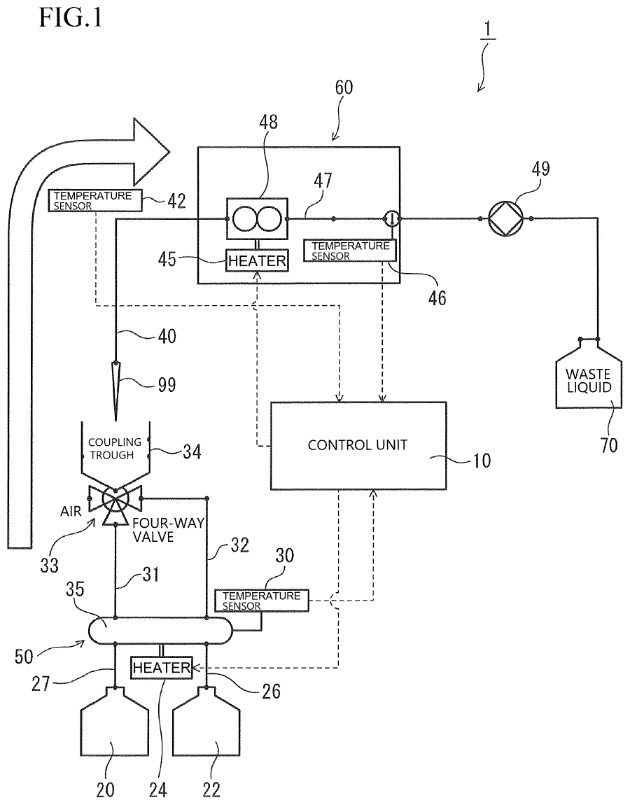

In the following description, the embodiment will be described using an analysis device for obtaining measurement information on a predetermined test item, for example, an automatic analysis device that includes a reaction unit that holds a reaction vessel into which a specimen such as blood or urine collected from a human is dispensed, and a reagent supply unit that supplies a reagent in a reagent vessel to the reaction vessel, and that measure a reacted and mixed liquid by supplying the reagent from the reagent supply unit to the reaction vessel and by mixing and reacting the reagent and the specimen with each other. Such an automatic analysis device includes a temperature adjustment system 1 illustrated in FIG. 1 as one embodiment of the invention. Incidentally, in the following embodiment, a case where heating is performed as the temperature adjustment function of a temperature adjustment unit to be described later will be provided as an example; however, the scope of the invention is not limited thereto, and also includes a case where temperature is adjusted through cooling.

As illustrated in FIG. 1, the temperature adjustment system 1 according to the present embodiment includes a heating unit 50 as a temperature adjustment unit for heating a liquid required for measurement to a desired temperature using a heater 24, and an introduction nozzle 99 that injects a measurement object into the liquid required for measurement which is heated by the heating unit 50, to form a “measurement object-containing liquid”. A measurement unit 60 that obtains measurement information on a predetermined analysis item from the measurement object-containing liquid is kept at a constant temperature by a heater 45. The heating unit 50 and the measurement unit 60 are connected by a connection flow path (sample introduction mechanism) 40 (details will be described later). The temperature adjustment system 1 according to the present embodiment includes a first temperature sensor (temperature detection unit) 30 that detects a temperature of the liquid required for measurement in the heating unit 50; a second temperature sensor (temperature detection unit) 46 that detects a temperature of the measurement object-containing liquid in the measurement unit 60; and a third temperature sensor 42 that detects an in-device temperature (in-machine temperature) of the automatic analysis device, and includes a control unit 10 that receives the temperature detection value from each of the temperature sensors 30, 42, and 46 to control the operation of the heater 24 of the heating unit 50. Incidentally, the operation of the heater 45 of the measurement unit 60 is controlled by another temperature sensor inside the measurement unit 60.

In the present embodiment, the heating unit 50 is configured as a temperature adjustment unit (temperature adjustment block) including a coiled tube 35 through which the liquid required for measurement passes, and heats the liquid required for measurement in the coiled tube 35 by heating the coiled tube 35 using the heater 24. In addition, liquid supply units 20 and 22 for supplying liquids required for various measurements are connected to the coiled tube 35 of the heating unit 50 via individual supply flow paths 26 and 27.

The measurement unit 60 includes an electrode 48 to which the measurement object-containing liquid is supplied, and includes an electrode flow path 47 through which the measurement object-containing liquid supplied from the connection flow path flows. The measurement unit 60 is configured by protecting the periphery of a metal box with a heat insulating material.

In addition, a coupling trough 34 with a four-way valve 33 is interposed between the heating unit 50 and the introduction nozzle 99. In this case, in addition to an air intake tube (not illustrated) communicating with the outside air, communication tubes 31 and 32 communicating with the corresponding liquid supply units 20 and 22 via the coiled tube 35 are connected to the four-way valve 33. The introduction nozzle 99 is joined to the coupling trough 34 except for when the introduction nozzle 99 moves to an installation location of the measurement object and suctions the measurement object, and forms a flow path between the coupling trough 34 and the connection flow path 40. After the introduction nozzle 99 that has suctioned the measurement object is joined to the coupling trough 34, the “liquid required for measurement” is mixed with the measurement object by moving through the introduction nozzle 99, to become the “measurement object-containing liquid”.

In addition, a pump (for example, a peristaltic pump) 49 that is driven to supply the liquid required for measurement from the liquid supply units 20 and 22 to the measurement unit 60 via the heating unit 50 is interposed on a downstream side of the electrode flow path 47 extending from the measurement unit 60, and a tank 70 that collects the measurement object-containing liquid and the like that has been measured, as waste liquid, is provided at a downstream end portion of the electrode flow path 47.

In the temperature adjustment system 1 according to the present embodiment having such a configuration, the heating unit 50 and the measurement unit 60 are spatially separated from each other. For this reason, when the outside air temperature is low, the liquid required for measurement and the measurement object-containing liquid undergoes a decrease (cooling) in temperature while flowing from the heating unit 50 to the measurement unit 60. An arrow of FIG. 1 indicates the flow channel (movement direction) of the measurement object-containing liquid.

The control unit 10 of the temperature adjustment system 1 according to the present embodiment controls the temperature of the heating unit 50 based on the temperature of the measurement object-containing liquid in the measurement unit 60 and the temperature of the liquid required for measurement in the heating unit 50 obtained by the temperature sensors 30 and 46. Namely, liquid temperature control is performed to control the temperature of the heating unit 50 (control the driving of the heater 24 in the example of FIG. 1) such that the temperature of the measurement object-containing liquid in the measurement unit 60 becomes a target temperature.

Specifically, the control unit 10 controls the heater 24 of the heating unit 50 to correct a temperature change (temperature decrease in FIG. 1) that occurs until the liquid required for measurement and the measurement object-containing liquid move from the heating unit 50 to the measurement unit 60 through the connection flow path 40. For example, in order to bring the temperature of the measurement object-containing liquid in the measurement unit 60 to the target temperature, the control unit 10 controls the heater 24 of the heating unit 50 such that the set temperature of the heating unit 50 becomes the total value (A+B) of A and B illustrated below.
A: Target temperature of the measurement object-containing liquid in the measurement unit 60
B: A temperature change associated with the flow of the liquid required for measurement and the measurement object-containing liquid from the heating unit 50 to the measurement unit 60 through the connection flow path 40 (a decrease or an increase: for example, the temperature change is calculated from a difference between a temperature of the measurement object-containing liquid in the measurement unit 60 at a measurement time and a temperature when the liquid required for measurement in the measurement object-containing liquid has passed through the temperature adjustment unit in the past, and the case of a decrease due to movement is defined as being positive and the case of an increase is defined as being negative)

In order to perform the foregoing control, the control unit 10 updates the temperature decreases associated with the flow of the liquid required for measurement and the measurement object-containing liquid, every predetermined time (for example, two seconds), and determines (updates) a set temperature of the heating unit 50 based on the update result. The temperature change B in the foregoing operational expression can be calculated, for example, as follows. The temperature of the liquid required for measurement in the heating unit 50 which is compared to a temperature C of the measurement object-containing liquid in the measurement unit 60 measured every two seconds is calculated using a temperature D (past temperature) of the liquid required for measurement in the heating unit 50 at a time earlier by an interval of time corresponding to the time taken for the liquid required for measurement to move from the heating unit 50 to the measurement unit 60.

Namely, a difference (C-D) between the temperature C (current value) of the measurement unit 60 and the temperature D (past value) of the heating unit 50 is set to the temperature change B (a decrease or an increase). Accordingly, the temperature change associated with the liquid temperature control can be suppressed, so that the temperature can be stabilized. Incidentally, it is desirable that a moving average of a plurality of measurement values acquired every two seconds is used as a measurement temperature used for control.

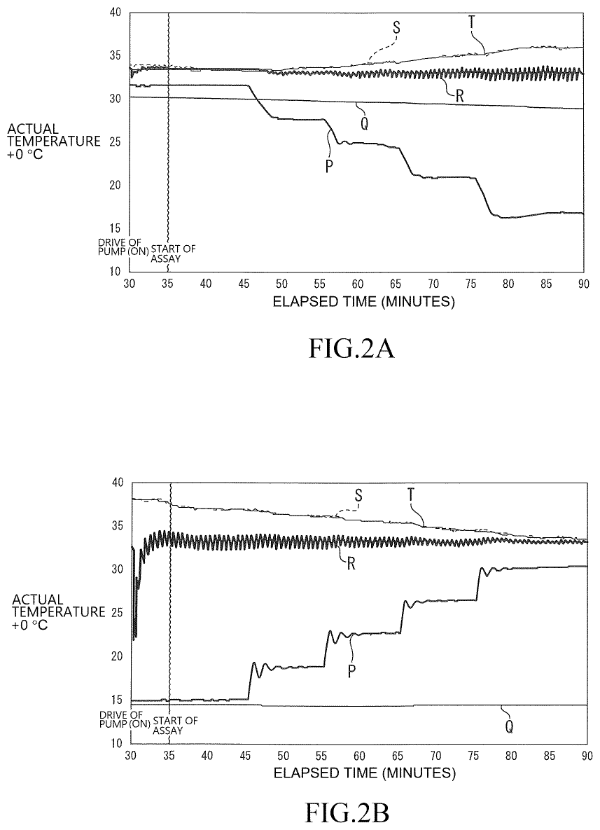

In the invention, instead of controlling the temperature of the heating unit 50 simply based on the outside air temperature as disclosed in Patent Document 2 described above, the temperature control of the heating unit 50 is performed based on the temperature of the measurement object-containing liquid in the measurement unit 60 and the past temperature of the liquid required for measurement in the heating unit 50 upstream of the measurement unit 60. Accordingly, the temperature of the measurement object-containing liquid in the measurement unit 60 can be accurately and precisely controlled to the target temperature. Experimental data demonstrating such liquid temperature control with excellent precision of the invention is illustrated in FIG. 2A and FIG. 2B (graphs illustrating a relationship between actual temperature (° C.) and elapsed time (minutes)).

FIG. 2A and FIG. 2B are diagrams (graphs) illustrating the temperature of each part during liquid temperature control according to the embodiment of the invention when the temperature in the inside of the device (in-device temperature (machine temperature)) which is the inside of the temperature adjustment system 1 is changed. In FIG. 2A and FIG. 2B, the machine temperature is a room temperature P. FIG. 2A is a graph illustrating temperature control when the in-device temperature (thermostatic chamber temperature: corresponding to the room temperature P) is decreased from 32° C. to 17° C. by approximately 4° C. every 10 minutes, and FIG. 2B is a graph illustrating temperature control when the in-device temperature (room temperature P) is increased from 15° C. to 30° C. by approximately 4° C. every 10 minutes. In the diagrams, each of the room temperature P, an installation liquid temperature Q, a temperature R of an electrode reaction unit liquid, and a coiled tube set temperature T is indicated by a solid line, and a temperature S of an outer surface of the coiled tube 35 is indicated by a broken line.

Incidentally, in the graphs, the installation liquid temperature Q is the temperature of the liquid required for measurement before being heated by the coiled tube 35, the temperature R of the electrode reaction unit liquid is the temperature of the measurement object-containing liquid in the measurement unit 60, the temperature S of the outer surface of the coiled tube 35 is the temperature of the outer surface of the coiled tube 35 corresponding to the temperature of the liquid required for measurement in the heating unit 50, and the coiled tube set temperature T is the set temperature of the heating unit 50 which is a control target of the control unit 10.

According to the invention, it can be seen from FIG. 2A and FIG. 2B that for example, even when the in-device temperature (room temperature P) changes due to a change in outside air temperature, heat dissipation from devices or elements inside the device after the device is operated, or the like, the temperature R of the measurement object-containing liquid in the measurement unit 60 can be accurately controlled to the target temperature. Specifically, in a case where the pump 49 is driven (ON) when the elapsed time reaches 30 minutes, an analysis is started (the start of an assay) when the elapsed time reaches 35 minutes, and the target temperature of the measurement object-containing liquid in the measurement unit 60 is set to 33° C., as illustrated in FIG. 2A, by increasing the set temperature T of the heating unit 50 based on the above-described operational expression (A+B) in association with a decrease in the room temperature P, the temperature R of the measurement object-containing liquid in the measurement unit is held around 33° C. (fluctuation of the average temperature of the electrode reaction unit liquid after the start of the assay is 32.9° C. to 33.6° C.).

In addition, as illustrated in FIG. 2B, by decreasing the set temperature T of the heating unit 50 based on the above-described operational expression in association with an increase in the room temperature P, the temperature R of the measurement object-containing liquid in the measurement unit 60 is held around 33° C. (fluctuation of the average temperature of the electrode reaction unit liquid after the start of the assay is 33.0° C. to 33.4° C.). Incidentally, although not illustrated, the same results were obtained even when the base was changed to another base with a machine difference.

In addition, in the liquid temperature control of FIG. 2A and FIG. 2B, the temperature R of the measurement object-containing liquid in the measurement unit 60 changes, for example, at a predetermined cycle (here, 36 seconds) according to a specimen measurement cycle or the like. For this reason, the control unit 10 controls the temperature of the heating unit 50 while considering a difference between the average value (moving average every 36 seconds) of the temperature of the measurement object-containing liquid in the measurement unit 60 which changes over a predetermined one cycle (36 seconds) of the change and the average value (moving average) of the temperature of the liquid required for measurement in the heating unit which changes over the one cycle and a past continuous predetermined period leading up to the cycle, as a temperature decrease associated with the flow of the liquid required for measurement and the measurement object-containing liquid (flow from the heating unit 50 to the measurement unit 60) over the predetermined one cycle.

In such a manner, in the invention, as a calculation period for obtaining the average value (moving average) of the changing temperature of the liquid required for measurement in the heating unit 50, a period in the past of a calculation period for obtaining the average value (moving average) of the changing temperature of the measurement object-containing liquid in the measurement unit 60 is used. Namely, the value of the temperature of the liquid required for measurement in the heating unit 50 at a certain time becomes a past value of the future temperature of the measurement object-containing liquid in the measurement unit 60. In the invention, by controlling the past value (value of the temperature of the liquid required for measurement in the heating unit 50) in advance in consideration of a future temperature change, the future temperature of the measurement object-containing liquid in the measurement unit 60 when the liquid required for measurement has moved to the measurement unit 60 thereafter is appropriately controlled.

In such a manner, the temperature decrease associated with the flow of the liquid required for measurement and the measurement object-containing liquid from the heating unit 50 to the measurement unit 60 through the connection flow path 40 is accurately detected, and the temperature is controlled to the set temperature of the heating unit 50 such that the temperature of the measurement object-containing liquid in the measurement unit 60 becomes the target temperature. Namely, the target temperature of the measurement object-containing liquid in the measurement unit 60+the temperature decrease associated with the flow of the liquid required for measurement and the measurement object-containing liquid from the heating unit 50 to the measurement unit 60 through the connection flow path 40 can be accurately determined.

In other words, since there is a time lag between the temperature of the measurement object-containing liquid in the measurement unit 60 and the temperature of the liquid required for measurement which flows through the heating unit 50 affecting the temperature of the measurement object-containing liquid in the measurement unit 60, the liquid temperature control can be performed with high accuracy by correcting the lags.

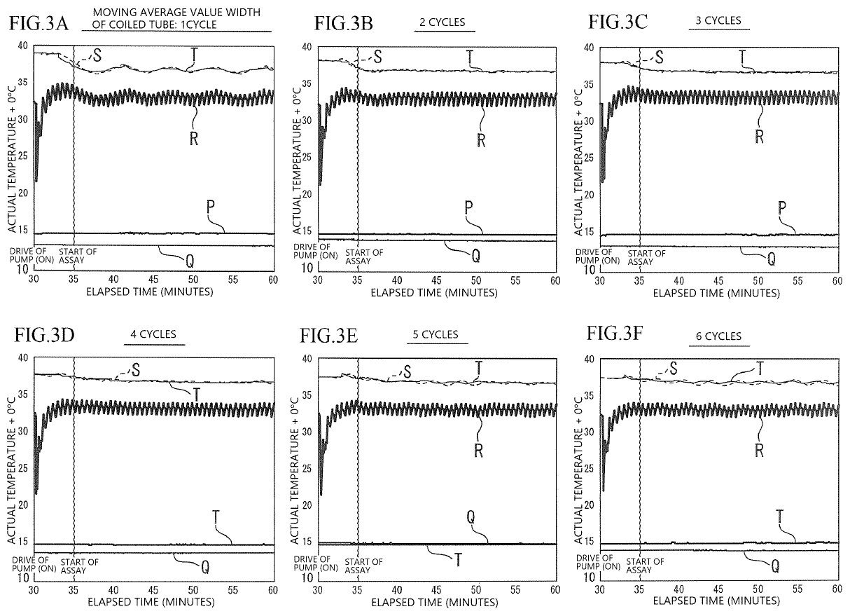

In addition, in this case, it is preferable that a period “spanning the predetermined one cycle and the past predetermined period that is continuous with the cycle” as the period for calculating the average value (moving average) of the changing temperature of the liquid required for measurement in the heating unit 50 is, for example, a period going back two to four cycles including the predetermined one cycle. Experimental data demonstrating this fact is illustrated in FIG. 3A, FIG. 3B, FIG. 3C, FIG. 3D, FIG. 3E and FIG. 3F. FIG. 3A, FIG. 3B, FIG. 3C, FIG. 3D, FIG. 3E and FIG. 3F are diagrams (graphs) corresponding to FIG. 2A and FIG. 2B when the room temperature P is constant, and are graphs when the moving average value width of the temperature (temperature detection value) of the liquid required for measurement in the heating unit 50 (period for calculating a moving average value of the changing temperature of the liquid required for measurement in the heating unit 50) is variously changed in consideration of a delay time from when the heating unit 50 reaches the set temperature to when the measurement object-containing liquid in the measurement unit 60 reaches the target temperature.

Specifically, FIG. 3A illustrates when the moving average value width is one cycle (period of the predetermined one cycle of the temperature change of the measurement object-containing liquid in the measurement unit 60: 36 seconds) (when the moving average value width is equal to a cycle of the temperature change of the measurement object-containing liquid in the measurement unit 60), FIG. 3B illustrates when the moving average value width is two cycles (period going back two cycles from the predetermined one cycle of the temperature change of the measurement object-containing liquid in the measurement unit 60, including the cycle: the same applies hereinafter), FIG. 3C illustrates when the moving average value width is three cycles, FIG. 3D illustrates when the moving average value width is four cycles, FIG. 3E illustrates when the moving average value width is five cycles, and FIG. 3F illustrates when the moving average value width is six cycles.

As can be seen from these diagrams, in FIG. 3A, FIG. 3E, and FIG. 3F in which the moving average value width is one cycle, five cycles, and six cycles, there is a large fluctuation in the temperature R of the measurement object-containing liquid in the measurement unit 60, however, in FIG. 3B, FIG. 3C, and FIG. 3D in which the moving average value width is two, three, and four cycles, there is almost no fluctuation in the temperature R of the measurement object-containing liquid in the measurement unit 60, and is constantly maintained around almost 33° C. Namely, it is preferable that the moving average value width is neither too small nor too large.

In addition, it is desirable that after the pump 49 is stopped, the control unit 10 performs machine temperature control (control based on the in-machine temperature when the pump 49 is stopped is referred to as “machine temperature control”) to control the temperature of the heating unit 50 to a predetermined constant temperature, based on the temperature inside the automatic analysis device (in-machine temperature). Since the measurement object-containing liquid is not supplied to the measurement unit 60 after the pump 49 is stopped, the liquid temperature control cannot be continued. For this reason, after the pump 49 is stopped, instead of the liquid temperature control, the machine temperature control is performed to control the temperature of the heating unit 50 based on a temperature determined in advance or a predetermined calculation formula according to the in-machine temperature.

Accordingly, compared to when the temperature adjustment control is completely stopped, after the driving of the pump 49 is restarted, the temperature of the measurement object-containing liquid in the measurement unit 60 can reach the target temperature as quickly as possible, which is advantageous. In addition, the configuration may be such that the measurement (analysis) efficiency of the entire device can be improved and the operating cost of the device can be reduced by combining the liquid temperature control and the machine temperature control during operation of the device.

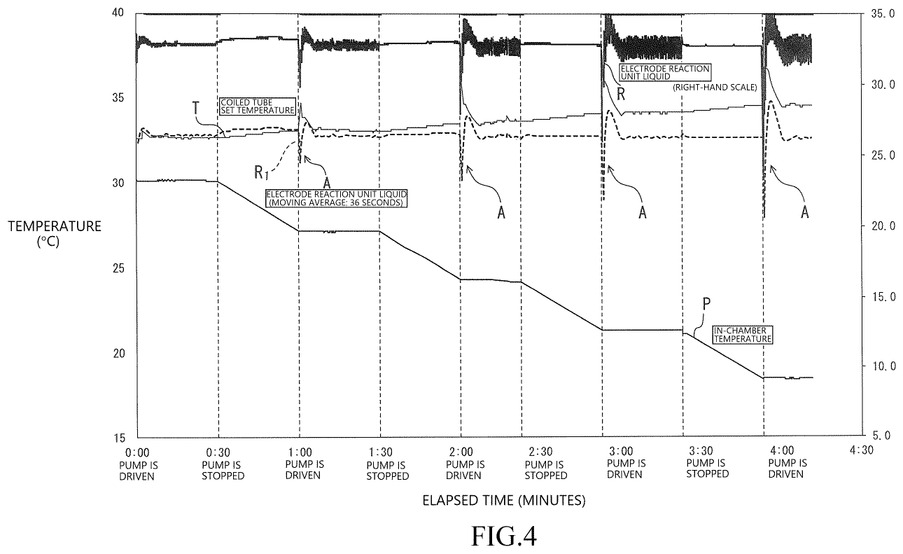

In addition, when the outside air temperature is low, after the power is turned on or immediately after the driving of the pump 49 is restarted after the pump 49 is stopped for a relatively long time under an environment where the outside air temperature is low, the measurement object-containing liquid of which the temperature is low due to being cooled by air is sent to the measurement unit 60. When a low temperature is detected as the temperature of the measurement object-containing liquid in the measurement unit 60, in the liquid temperature control, control is performed to set the set temperature of the heating unit 50 at a high temperature. For this reason, immediately after the driving of the pump is started, the temperature of the measurement object-containing liquid in the measurement unit 60 suddenly increases, so that it takes a long time for the measurement object-containing liquid in the measurement unit 60 to stabilize at the target temperature. FIG. 4 is experimental data illustrating such a state.

FIG. 4 is a graph illustrating each measurement results over time of the in-device temperature (in-chamber temperature: machine temperature) P, a moving average value R1 of the moving average width of the temperature R of the electrode reaction unit liquid (temperature of the measurement object-containing liquid in the measurement unit 60) for 36 seconds, and the coiled tube set temperature (set temperature of the heating unit 50) T. FIG. 4 illustrates when the liquid temperature control is performed simultaneously with driving the pump 49 and the machine temperature control is performed simultaneously with stopping the pump 49 (when the driving and stop of the pump are repeatedly every 30 minutes).

Incidentally, at the top of the diagram, measurement data (for example, measurement values every two seconds) of the temperature R of the electrode reaction unit liquid (temperature of the measurement object-containing liquid in the measurement unit 60) is illustrated. The moving average value R1 of the temperature R of the electrode reaction unit liquid is calculated based on the temperature R of the electrode reaction unit liquid. The temperature unit of the temperature R of the electrode reaction unit liquid illustrated at the uppermost part of the diagram is represented by the right vertical axis of the graph, and all the temperature reference units of the other temperatures T, R1, A, and P are represented by the left vertical axis. In addition, in order to clearly illustrate temperature changes in the moving average value R1 of the temperature of the electrode reaction unit liquid and in the coiled tube set temperature T, the moving average value R1 of the temperature of the electrode reaction unit liquid and the coiled tube set temperature T are illustrated in the vicinity of the center of FIG. 4 in an up-down direction by a broken line and a solid line, respectively, with reference to the temperature on the left vertical axis which is common to both.

As can be seen from FIG. 4, control is performed such that the lower the in-device temperature (in-chamber temperature) P is and the lower the temperature of the measurement object-containing liquid is, the temperature of the measurement object-containing liquid being sent to the measurement unit 60 immediately after the pump 49 is driven, as at portions A indicated by arrows in the diagram, immediately after the pump 49 is driven, the higher the set temperature T of the heating unit 50 is. For this reason, thereafter, the temperature R of the measurement object-containing liquid reaching the measurement unit 60 suddenly increases, so that it takes a long time for the measurement object-containing liquid in the measurement unit 60 to stabilize at the target temperature.

For this reason, in the present embodiment, immediately before the measurement object-containing liquid is measured by the measurement unit 60 during the liquid temperature control, the pump 49 is driven to introduce a dummy liquid from the heating unit 50 to the measurement unit 60, instead of the measurement object-containing liquid, and thereafter, the liquid temperature control is started. Accordingly, the time taken for the measurement object-containing liquid in the measurement unit 60 to stabilize at the target temperature can be shortened, and the measurement (analysis) efficiency can be improved.

Here, it is desirable that the “dummy liquid” is a liquid not containing the measurement object and heated by the heating unit and is a liquid required for measurement. However, the dummy liquid is not limited thereto, and any liquid can be used as the “dummy liquid” as long as the liquid can shorten the time taken for the measurement object-containing liquid in the measurement unit 60 to stabilize at the target temperature, namely, the liquid can recover the measurement object-containing liquid in the measurement unit 60 to the target temperature.

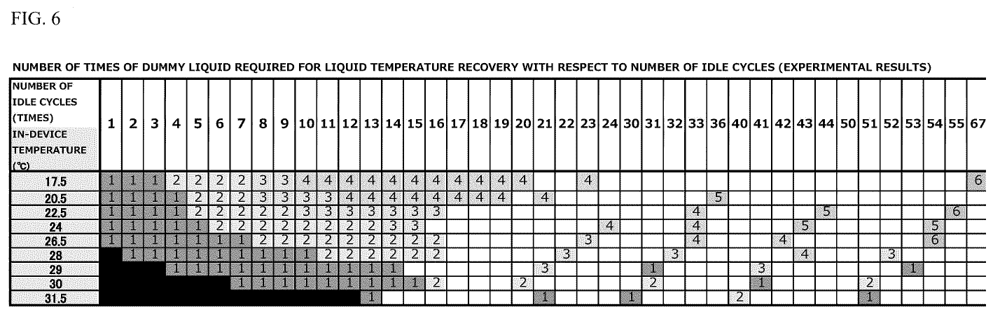

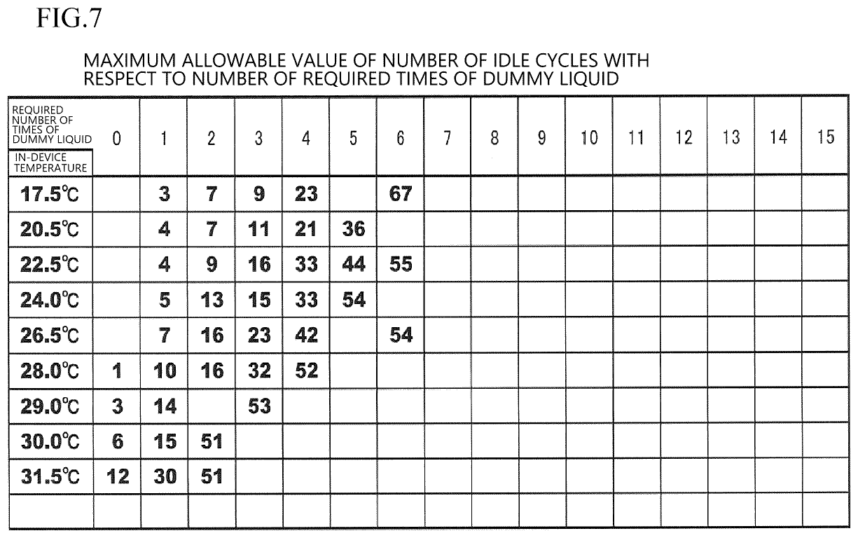

In addition, in the present embodiment, the introduction period of the dummy liquid can be determined in association with the temperature inside the automatic analysis device and the time from when the pump 49 is stopped to when the driving of the pump 49 is restarted (stop continuation time of the pump 49). With such an association, the usage amount of the dummy liquid required to shorten the time taken for the measurement object-containing liquid in the measurement unit 60 to stabilize at the target temperature can be appropriately set, and a situation where the dummy liquid is used wastefully can be avoided. Experimental data regarding the introduction period of the dummy liquid is illustrated in FIG. 6 and FIG. 7.

FIG. 6 is a diagram (table) illustrating experimental data illustrating the time from when the pump 49 is stopped to when the driving of the pump 49 is restarted (the number of idle cycles which is the stop continuation time of the pump 49) and the flow time of the dummy liquid required to recover the temperature of the measurement object-containing liquid in the measurement unit 60 to the target temperature when measurement is restarted (the number of required cycles) for each in-device temperature (in-machine temperature).

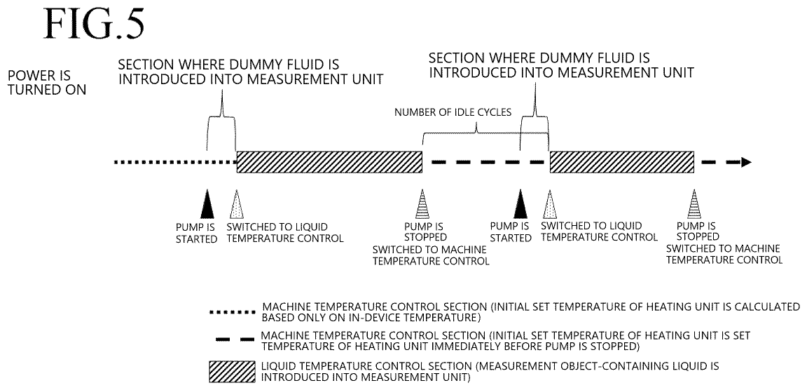

Incidentally, regarding the number of cycles used as a unit in FIG. 6 and FIG. 7 and FIG. 5 to be described below, a predetermined change cycle at which the measurement object-containing liquid in the measurement unit 60 changes is defined as one cycle, and the example of FIG. 6 illustrates a case where 36 seconds are defined as “one cycle”.

Here, since the dummy liquid is introduced into the measurement unit 60 by driving the pump 49 immediately before the restart of the driving of the pump 49, it is preferable that the actual stop continuation time of the pump 49 when the dummy liquid is introduced is obtained by subtracting the number of required times (the number of cycles) of the dummy liquid from the number of idle cycles.

In addition, FIG. 6 and FIG. 7 illustrate experimental results when the temperature control of the heating unit 50 using the dummy liquid is performed by the machine temperature control.

According to FIG. 6, for example, when the number of idle cycles which is the stop continuation time of the pump 49 is five times (five cycles), it can be seen that when the in-device temperature is 24.0° C. or higher, the measurement object-containing liquid in the measurement unit 60 can be recovered to the target temperature by introducing the dummy liquid over a period of one time (one cycle). On the other hand, when the in-device temperature is lower than 24.0° C., the measurement object-containing liquid in the measurement unit 60 cannot be recovered to the target temperature unless the dummy liquid is introduced over a period of two times (two cycles).

Alternatively, looking at the table from another perspective, when the in-device temperature is 20.5° C. to 22.5° C., and the number of idle cycles is five to seven times, the introduction period of the dummy liquid required to recover the measurement object-containing liquid in the measurement unit 60 to the target temperature needs to be only two times (two cycles). Alternatively, when the in-device temperature is 30.0° C. to 31.5° C., and the number of idle cycles is 16 to 51 times, the introduction period of the dummy liquid required to recover the measurement object-containing liquid in the measurement unit 60 to the target temperature needs to be only two times (two cycles) at maximum.

On the other hand, FIG. 7 is a diagram (table) in which the experimental results of FIG. 6 are rewritten as data illustrating the maximum allowable value of the number of idle cycles with respect to the number of required times of the dummy liquid for each in-device temperature. Looking at FIG. 7, when the in-device temperature is 20.5° C. to 22.5° C., and as described above, the number of idle cycles is five to seven times, the introduction period of the dummy liquid required to recover the measurement object-containing liquid in the measurement unit 60 to the target temperature needs to be only two times (two cycles). When the in-device temperature is 20.5° C., and the number of required times of the dummy liquid is 2, the maximum allowable number of idle cycles is 7.

Similarly, when the in-device temperature is 30.0° C. to 31.5° C., and as described above, the number of idle cycles is 16 to 51 times, the introduction period of the dummy liquid required to recover the measurement object-containing liquid in the measurement unit 60 to the target temperature needs to be only two times (two cycles) at maximum, so that when the number of required times of the dummy liquid is 2, the maximum allowable number of idle cycles is 51.

Unlike FIG. 6 and FIG. 7, FIG. 5 illustrates one example of the temperature adjustment cycle of the temperature adjustment system 1 that performs temperature control through a combination of the machine temperature control and the liquid temperature control using the dummy liquid. Incidentally, since there is no measurement data when the power of the device is turned on, it is desirable that the initial value of the set temperature of the heating unit 50 is acquired based only on the in-device temperature (in-machine temperature) when the power is turned on. Here, the initial value of the set temperature may be calculated as, for example, −a×in-device temperature+b. It is preferable that for the values of a and b, during the design of the device, temperature data of the heating unit 50 in which the temperature of the measurement object-containing liquid in the measurement unit 60 becomes a desired value in a state where the pump 49 is driven is acquired according to the in-device temperature, and appropriate values based on the temperature data are determined in advance.

For example, when experimental data illustrating that the temperature of the heating unit 50 at which the temperature of the measurement object-containing liquid in the measurement unit 60 becomes 33.0° C. is 36.8° C. at an in-device temperature of 16.1° C. and is 33.2° C. at an in-device temperature of 29.6° C. is obtained, the values of a and b are calculated as a=−(36.8−33.2)÷(16.1−29.6)=0.267 and b=36.8+a×16.1=36.8+0.267×16.1=41.1. In the case of using data obtained when the in-device temperature is changed three or more times, a regression equation is calculated from each data value to determine a and b; however, in a case where a regression equation other than a linear regression equation is adopted, the regression equation is replaced with an appropriate function.

As described above, after the pump 49 is stopped, the machine temperature control can be performed to control the temperature of the heating unit 50 to the predetermined temperature based on the temperature inside the automatic analysis device. In the machine temperature control, after the initial value of the set temperature of the heating unit 50 is acquired from the in-device temperature when the power of the device is turned on, the set temperature of the heating unit 50 can be corrected according to the amount of a change in the in-device temperature (in-machine temperature) from when the initial value is acquired. For example, assuming that the in-machine temperature increases to a certain extent due to power-on, the set temperature when the in-machine temperature is controlled may be set to the set temperature of the heating unit when the initial value is acquired −a×(current in-device temperature−in-device temperature when the initial value is acquired). In addition, as described above, it is desirable that during the liquid temperature control, the control unit 10 updates the set temperature of the heating unit 50 every predetermined time such that the temperature of the measurement object-containing liquid in the measurement unit 60 becomes the target temperature, but after the pump 49 is stopped, determines the set temperature immediately before the stop as the initial value of the set temperature of the heating unit 50 during the machine temperature control.

When the pump 49 is driven from a pump stop state where such machine temperature control is performed, as illustrated in FIG. 5, air temperature control (machine temperature control) is switched to the liquid temperature control via a section in which the dummy liquid is introduced into the measurement unit 60 (section until the influence of air cooling decreases after the pump is driven), and the measurement of the measurement object-containing liquid by the measurement unit 60 is started. In the present embodiment, in the section in which the dummy liquid is introduced into the measurement unit, the dummy liquid is introduced into the measurement unit 60 through the heating unit 50, and on the other hand, in a liquid temperature control section, instead of the dummy liquid, the measurement object-containing liquid is introduced into the measurement unit 60.

Thereafter, when the pump 49 is stopped, the liquid temperature control is switched to the machine temperature control again. Thereafter, when the pump 49 is driven again, similarly as before, the machine temperature control is switched to the liquid temperature control via the section in which the dummy liquid is introduced into the measurement unit 60, and the measurement of the measurement object-containing liquid by the measurement unit 60 is started. Thereafter, when the pump 49 is stopped, the liquid temperature control is switched to the machine temperature control again. Incidentally, by continuing to introduce the dummy liquid into the measurement unit for a certain period even after switching to the liquid temperature control, the accuracy of the measurement object-containing liquid in the measurement unit 60 reaching the target temperature can also be further improved.

As described above, according to the automatic analysis device 1 of the present embodiment, the liquid temperature control is performed not only to control the temperature of the heating unit 50 according to the outside air temperature, but also to control the temperature of the heating unit 50 such that the temperature of the measurement object-containing liquid in the measurement unit 60 becomes the target temperature, based on the temperature of the measurement object-containing liquid in the measurement unit 60 and the temperature of the liquid required for measurement in the heating unit 50. For this reason, even when there is a machine-to-machine difference in the heat insulation of the device, the temperature of the measurement object-containing liquid can be accurately controlled to the target temperature in the measurement unit 60 without performing an adjustment for each machine.

Moreover, in such liquid temperature control, according to the present embodiment, since the temperature decrease associated with the flow of the liquid required for measurement and the measurement object-containing liquid from the heating unit 50 to the measurement unit 60 through the connection flow path 40 is taken into consideration, even when the heating unit 50 and the measurement unit 60 are spatially separated from each other by a distance such that the liquid required for measurement and the measurement object-containing liquid heated by the heating unit 50 undergo a decrease (cooling) in temperature until reaching the measurement unit 60 (corresponding to the present embodiment), the temperature of the measurement object-containing liquid can be accurately set to the desired temperature in the measurement unit 60.

Incidentally, the invention is not limited to the above-described embodiment, and can be modified and implemented in various forms without departing from the concept of the invention. For example, in the invention, the configuration of the heating unit, the measurement unit, or the like is not limited to the above-described configuration. In addition, the flow (switching timing) of the temperature adjustment cycle of the temperature adjustment system 1 is not limited to the above-described flow illustrated in FIG. 5. In addition, in FIG. 5, conditions for selecting the section in which the dummy liquid is introduced into the measurement unit can also be set in various manners.

In addition, in the above-described embodiment, when the temperature of the measurement object-containing liquid in the measurement unit changes at a predetermined cycle, the control unit considers a difference between the average value (moving average) of the temperature of the measurement object-containing liquid in the measurement unit which changes over a predetermined one cycle of the change and the average value (moving average) of the temperature of the liquid required for measurement in the heating unit which changes over the one cycle and the past predetermined period that is continuous with the cycle, as the temperature decrease associated with the flow of the liquid required for measurement and the measurement object-containing liquid over the predetermined one cycle. However, the calculation period of the moving average in the heating unit may be a past predetermined period including or not including the one cycle. In the liquid temperature control, the control unit may control the temperature of the temperature adjustment unit while considering a difference between the temperature of the measurement object-containing liquid in the measurement unit and the temperature of the liquid required for measurement in the heating unit (temperature adjustment unit) at a past time as the temperature change associated with the flow of the liquid required for measurement and the measurement object-containing liquid.

In addition, in the embodiment, as various examples of the moving averages of temperatures in the heating unit 50 and the measurement unit, a dummy cycle, and the like, an example in which the “predetermined one cycle (one cycle)” is one unit is provided; however, the invention is not limited thereto, and the units of the cycle of the moving average, the dummy cycle, and the like can be freely determined. Further, some or all of the above-described embodiments may be combined without departing the concept of the invention, or some of the configurations may be omitted from one of the above-described embodiments.

What is claimed is:

1. A temperature adjustment system for an automatic analysis device to obtain measurement information on a predetermined analysis item by processing and measuring a specimen, the system comprising:
a temperature adjustment unit for adjusting a temperature of a liquid required for measurement to a desired temperature;
a measurement unit for obtaining measurement information on a predetermined analysis item of a measurement object-containing liquid obtained by adding a measurement object to the liquid required for measurement, the liquid temperature of the liquid required for measurement being adjusted by the temperature adjustment unit;
a connection flow path connecting the temperature adjustment unit and the measurement unit;
a temperature detection unit to detect a temperature of the liquid required for measurement in the temperature adjustment unit and a temperature of the measurement object-containing liquid in the measurement unit; and
a control unit to receive the detected temperatures from the temperature detection unit, to calculate a temperature change associated with a flow of the liquid required for measurement and the measurement object-containing liquid from the temperature adjustment unit to the measurement unit through the connection flow path, based on the temperature of the measurement object-containing liquid in the measurement unit and the temperature of the liquid required for measurement in the temperature adjustment unit, and to perform liquid temperature control to control a temperature of the temperature adjustment unit such that the temperature of the measurement object-containing liquid in the measurement unit becomes a target temperature, based on the target temperature and the temperature change.

2. The temperature adjustment system for the automatic analysis device according to claim 1,
wherein in the liquid temperature control, the control unit controls the temperature of the temperature adjustment unit while considering a temperature difference between the temperature of the measurement object-containing liquid in the measurement unit and a temperature at a past time the liquid required for measurement passes through the temperature adjustment unit, the liquid required for measurement being contained in the measurement object-containing liquid measured for the temperature, or a temperature in a period including the past time, as the temperature change associated with the flow of the liquid required for measurement and the measurement object-containing liquid.

3. The temperature adjustment system for the automatic analysis device according to claim 1,
wherein in the liquid temperature control, when the temperature of the measurement object-containing liquid in the measurement unit changes at a predetermined cycle,
the control unit controls the temperature of the temperature adjustment unit while considering a difference between an average value of the temperature of the measurement object-containing liquid in the measurement unit over a period of one cycle, the temperature changing over the predetermined cycle, and an average value of the temperature of the liquid required for measurement in the temperature adjustment unit, the temperature changing over a past predetermined period including or not including the period of one cycle, as the temperature change associated with the flow of the liquid required for measurement and the measurement object-containing liquid over the predetermined one cycle.

4. The temperature adjustment system for the automatic analysis device according to claim 2,
wherein in the liquid temperature control, when the temperature of the measurement object-containing liquid in the measurement unit changes at a predetermined cycle,
the control unit controls the temperature of the temperature adjustment unit while considering a difference between an average value of the temperature of the measurement object-containing liquid in the measurement unit over a period of one cycle, the temperature changing over the predetermined cycle, and an average value of the temperature of the liquid required for measurement in the temperature adjustment unit, the temperature changing over a past predetermined period including or not including the period of one cycle, as the temperature change associated with the flow of the liquid required for measurement and the measurement object-containing liquid over the predetermined one cycle.

5. The temperature adjustment system for the automatic analysis device according to claim 1,
wherein the control unit updates the temperature change associated with the flow of the liquid required for measurement and the measurement object-containing liquid, every predetermined time, and determines a set temperature of the temperature adjustment unit such that the temperature of the measurement object-containing liquid in the measurement unit becomes a target temperature, based on an update result.

6. The temperature adjustment system for the automatic analysis device according to claim 2,
wherein the control unit updates the temperature change associated with the flow of the liquid required for measurement and the measurement object-containing liquid, every predetermined time, and determines a set temperature of the temperature adjustment unit such that the temperature of the measurement object-containing liquid in the measurement unit becomes a target temperature, based on an update result.

7. The temperature adjustment system for the automatic analysis device according to claim 1,
wherein after a pump to supply the liquid required for measurement to the measurement unit via the temperature adjustment unit is stopped, the control unit performs machine temperature control to control the temperature of the temperature adjustment unit to a predetermined temperature, based on an in-machine temperature of the automatic analysis device.

8. The temperature adjustment system for the automatic analysis device according to claim 2,
wherein after a pump to supply the liquid required for measurement to the measurement unit via the temperature adjustment unit is stopped, the control unit performs machine temperature control to control the temperature of the temperature adjustment unit to a predetermined temperature, based on an in-machine temperature of the automatic analysis device.

9. The temperature adjustment system for the automatic analysis device according to claim 7,
wherein during the liquid temperature control, the control unit updates a set temperature of the temperature adjustment unit every predetermined time such that the temperature of the measurement object-containing liquid in the measurement unit becomes a target temperature, and after the pump is stopped, determines the set temperature immediately before the stop as an initial value of a set temperature of the temperature adjustment unit during the machine temperature control.

10. The temperature adjustment system for the automatic analysis device according to claim 8,
wherein during the liquid temperature control, the control unit updates a set temperature of the temperature adjustment unit every predetermined time such that the temperature of the measurement object-containing liquid in the measurement unit becomes a target temperature, and after the pump is stopped, determines the set temperature immediately before the stop as an initial value of a set temperature of the temperature adjustment unit during the machine temperature control.

11. The temperature adjustment system for the automatic analysis device according to claim 7,
wherein after the pump is driven and before the measurement object-containing liquid is measured by the measurement unit, instead of the measurement object-containing liquid, a dummy liquid is caused to flow from the temperature adjustment unit to the measurement unit for a predetermined period, and then the liquid temperature control is performed.

12. The temperature adjustment system for the automatic analysis device according to claim 8,
wherein after the pump is driven and before the measurement object-containing liquid is measured by the measurement unit, instead of the measurement object-containing liquid, a dummy liquid is caused to flow from the temperature adjustment unit to the measurement unit for a predetermined period, and then the liquid temperature control is performed.

13. The temperature adjustment system for the automatic analysis device according to claim 9,
wherein after the pump is driven and before the measurement object-containing liquid is measured by the measurement unit, instead of the measurement object-containing liquid, a dummy liquid is caused to flow from the temperature adjustment unit to the measurement unit for a predetermined period, and then the liquid temperature control is performed.

14. The temperature adjustment system for the automatic analysis device according to claim 10,
wherein after the pump is driven and before the measurement object-containing liquid is measured by the measurement unit, instead of the measurement object-containing liquid, a dummy liquid is caused to flow from the temperature adjustment unit to the measurement unit for a predetermined period, and then the liquid temperature control is performed.

15. The temperature adjustment system for the automatic analysis device according to claim 11,
wherein the predetermined period of the adjustment by the dummy liquid is associated with a temperature inside the automatic analysis device and a time from when the pump is stopped to when a driving of the pump is restarted.

16. The temperature adjustment system for the automatic analysis device according to claim 12,
wherein the predetermined period of the adjustment by the dummy liquid is associated with a temperature inside the automatic analysis device and a time from when the pump is stopped to when a driving of the pump is restarted.

17. The temperature adjustment system for the automatic analysis device according to claim 13,
wherein the predetermined period of the adjustment by the dummy liquid is associated with a temperature inside the automatic analysis device and a time from when the pump is stopped to when a driving of the pump is restarted.

18. The temperature adjustment system for the automatic analysis device according to claim 14,
wherein the predetermined period of the adjustment by the dummy liquid is associated with a temperature inside the automatic analysis device and a time from when the pump is stopped to when a driving of the pump is restarted.
